(19) United States
(12) Patent Application Publication
(10) Pub. No.: US 2026/0329415 A1
(43) Pub. Date: Oct. 22, 2026

(54) DISPLAY METHOD AND APPARATUS, COMPUTING DEVICE, MEDIUM AND PROGRAM PRODUCT

(71) Applicant: Bytedance Technology Ltd., Grand Cayman (KY)

(72) Inventors: Chenyun Zeng, Beijing (CN); Shengfan He, Beijing (CN)

(21) Appl. No.: 19/651,303

(22) Filed: Apr. 17, 2026

(30) Foreign Application Priority Data
Apr. 18, 2025 (CN) 202510495118.4

(51) Int. Cl. G06F 3/0483; G06F 3/0482

(52) U.S. Cl. CPC G06F 3/0483; G06F 3/0482

(57) ABSTRACT

The present disclosure provides a display method and apparatus, a computing device, a medium and a computer program product. The method includes: displaying a navigation bar of a first page in a view of the first page, the navigation bar including an interactive element that hides path information of the first page, and a first title of the first page. The method also includes: in response to receiving a first interactive operation to the interactive element, displaying a title of at least one page in the hidden path information; and in response to receiving a second interactive operation to a second title of a second page among the at least one page, adding the second title to the navigation bar.

### CROSS-REFERENCE TO RELATED APPLICATION(S)

This application claims priority to Chinese Application No. 202510495118.4 filed on Apr. 18, 2025, the disclosure of which is incorporated herein by reference in its entirety.

### FIELD

The present disclosure relates to the technical field of computers, and more specifically, to a display method and apparatus, a computing device, a computer storage medium and a computer program product.

### BACKGROUND

In page design, a navigation bar—often referred to as a “breadcrumb” or “address bar”—is commonly used to represent a hierarchical navigation structure. The navigation bar is typically displayed as a horizontal string of text separated by symbols (e.g., “>” or “/”), clearly indicating the user's navigation path from the homepage to the current page. For example, in an information-based application, if a user is viewing an article within the technology section, the navigation path may appear as “Home>Information>Technology>[Article Title].” This allows the user to easily understand their current location within the site and quickly return to an intermediate page in the path, thereby enhancing browsing efficiency. However, there remains a need to further improve navigation bar design in order to overcome existing shortcomings and address emerging user demands.

### SUMMARY

In a first aspect of embodiments of the present disclosure, there is provided a display method, comprising: displaying a navigation bar of a first page in a view of the first page, the navigation bar including an interactive element that hides path information of the first page, and a first title of the first page; in response to receiving a first interactive operation to the interactive element, displaying a title of at least one page in the hidden path information; and in response to receiving a second interactive operation to a second title of a second page among the at least one page, adding the second title to the navigation bar.

In a second aspect of embodiments of the present disclosure, there is provided a display apparatus, comprising: a first display unit configured to display a navigation bar of a first page in a view of the first page, the navigation bar including an interactive element that hides path information of the first page, and a first title of the first page; a second display unit configured, in response to receiving a first interactive operation to the interactive element, to display a title of at least one page in the hidden path information; and a title adding unit configured, in response to receiving a second interactive operation to a second title of a second page among the at least one page, to add the second title to the navigation bar.

In a third aspect of embodiments of the present disclosure, there is provided an electronic device, comprising: at least one processing unit; and at least one memory coupled to the at least one processing unit and storing instructions executable by the at least one processing unit, wherein the instructions, when executed by the at least one processing unit, cause the electronic device to perform the method in the first aspect of the present disclosure.

In a fourth aspect of the present disclosure, there is provided a computer-readable storage medium, comprising machine-executable instructions that, when executed by a device, cause the device to perform the method in the first aspect of the present disclosure.

In a fifth aspect of the present disclosure, there is provided a computer program product comprising machine-executable instructions that, when executed by a device, cause the device to perform the method in the first aspect of the present disclosure.

It would be appreciated that the Summary is not intended to identify key features or essential features of the present disclosure, nor is it intended to be used to limit the scope of the present disclosure. Other features of the present disclosure will be made apparent through the following description.

### BRIEF DESCRIPTION OF THE DRAWINGS

With reference to the following detailed description of the accompanying drawings, the above and other objectives, features, and advantages of the embodiments of the present disclosure will be made clearer. Wherein:

FIG. 1 illustrates an example page view including a separate page title and a navigation bar;

FIG. 2 illustrates an example flowchart of a display method according to some embodiments of the present disclosure;

FIGS. 3-11 illustrate schematic diagrams of a navigation bar according to some embodiments of the present disclosure, respectively;

FIG. 12 illustrates a schematic block diagram of a display apparatus according to some embodiments of the present disclosure; and

FIG. 13 illustrates a schematic block diagram of a device that can implement a plurality of embodiments of the present disclosure.

Throughout the drawings, the same or similar reference numerals represent the same or similar elements.

### DETAILED DESCRIPTION OF EMBODIMENTS

It would be appreciated that all user-related data involved in the present technical solution should be obtained and used after user authorization has been gained. In other words, according to the present technical solution, if user's personal information is to be used, express consent and authorization from the user are required before obtaining the data; otherwise, the related data should not be collected or used. Further, when the technical solution is being carried out, the behavior of collecting, using and storing the data should strictly comply with the relevant laws and regulations, and necessary technologies and measures should be adopted to protect the user data security and ensure safe use of the data.

Prior to applying the technical solution, in accordance with the relevant laws and regulations, the user should be informed of the type, scope of use, and use scenario of the personal information involved in an appropriate manner, and user authorization should be obtained.

For example, in response to receiving an active request from a user, prompt information is sent to the user to explicitly inform the user that the requested operation would acquire and use the user's personal information. Therefore, according to the prompt information, the user may decide on his/her own whether to provide the personal information to software or hardware, such as electronic devices, applications, servers or storage media that perform operations of the technical solution of the present disclosure.

As an optional implementation, without limitation, in response to receiving an active request from a user, the method of sending prompt information to the user may, for example, include a pop-up window, where the prompt information may be presented in the form of text in the pop-up window. In addition, the pop-up window may also carry a select control for the user to choose to “agree” or “disagree” to provide the personal information to the electronic device.

The above process of notifying and obtaining the user authorization is only illustrative, and other methods compliant with the provisions of the relevant laws and regulations can also be applied to the implementations of the present disclosure.

Reference below will be made to describe the embodiments of the present disclosure in detail. Although some embodiments of the present disclosure are depicted in the drawings, it would be appreciated that the present disclosure could be implemented in various forms and should not be construed as being restricted to the embodiments described herein. Rather, those embodiments are provided to enable a more thorough and complete understanding of the present disclosure. It is to be understood that the drawings and embodiments of the present disclosure are provided only exemplarily, but not used to limit the protection scope of the present disclosure.

As described herein, the term “includes” or similar expressions are to be read as open-ended terms that mean “includes, but is not limited to.” The term “based on” is to be read as “based at least in part on.” The term “an embodiment” or “the embodiment” is to be read as “at least one embodiment.” The terms “first,” “second,” and the like may refer to different objects or the same object unless explicitly indicated otherwise. Other definitions, explicit and implicit, may be included below.

The navigation bar is a common tool for a page design or in an interaction scenario. During the user operation, the navigation bar displays path traces of a user. An information application is taken herein as an example. If a user is browsing an article in the technology section, the navigation path may be “Home>Information>Technology>[Article Title].” By clicking on a title of other page displayed in the navigation bar, the user can quickly jump to any previously browsed page. In an application according to the prior art, the navigation bar and the title of the current page are displayed separately. Typically, the title and the navigation bar are displayed one above the other, or one of them is displayed on the left while the other one is on the right.

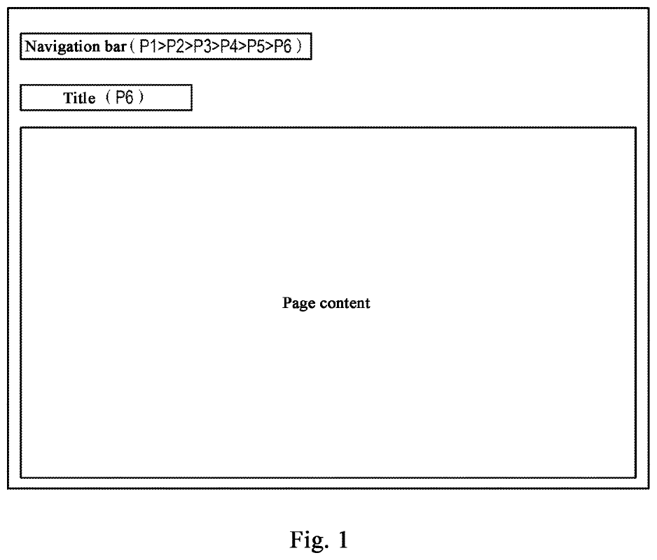

FIG. 1 illustrates an example page including a separate navigation bar and a title, where the navigation bar and the title are arranged vertically. In FIG. 1, the navigation bar shows path information (P1>P2>P3>P4>P5>P6) of the current page, and the title (P6) of the current page is located there below. Separate display of the navigation bar and the title results in inefficient use of the page space and redundant information (repeated display of the title P6 of the current page).

In some existing web page designs, the navigation bar is directly used as the title while the page title is omitted, in order to save the space. However, such solutions may result in a less prominent title since the font in the navigation bar is generally small. This issue becomes more evident when the path information is lengthy, causing the font size of the final title segment in the navigation bar to appear even smaller, which may inconvenience users. Therefore, there is a need for further optimizing and improving the interaction between the navigation bar and the page title.

In view of the above, embodiments of the present disclosure provide an improved solution in which the navigation bar and the page title are integrated into a unified navigation tool, and the navigation bar is displayed in a flexible manner through an interactive mechanism. In some embodiments, the title of the current page may be displayed within the navigation bar, with an interactive element (e.g., an ellipsis button) positioned next to the title to hide the path information of the current page. The user may interact with the element to expand or collapse the hidden portions of the navigation path. In this way, the present disclosure enables the simultaneous display of both the navigation bar and the page title without increasing the space occupied by the navigation area. It preserves the functions of showing the current title and allowing access to intermediate path pages, while also achieving improved space efficiency. The pages in the navigation path may be selectively displayed or hidden, and users can customize the visibility of specific pages according to their preferences, thereby addressing the problem of overly long and inflexible navigation bars in conventional designs.

It is worth noting that a page design application is used herein as an example to describe the embodiments of the present disclosure. However, the technical concept of the present disclosure may also be applied to other application scenarios, such as displaying a file and an address bar containing file path information in an operating system window.

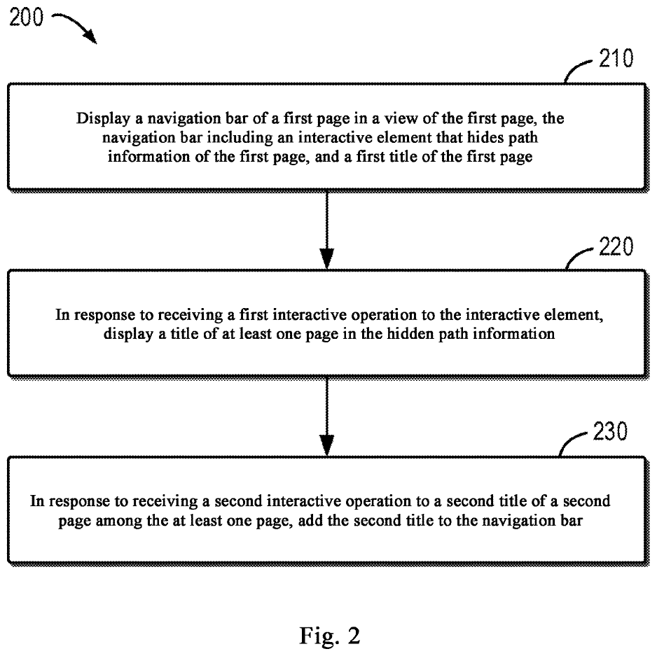

FIG. 2 illustrates a flowchart of a display method 200 according to some embodiments of the present disclosure. The method can be implemented by any electronic device with computing and display capabilities, including, but not limited to, a mobile phone, a tablet, a wearable device, an on-vehicle device, an augmented reality/virtual reality device, a laptop computer, an ultra-mobile personal computer, a netbook computer, a personal digital assistant, an IoT device, an industrial terminal, and other electronic device with an interface display function. The specific type of the electronic device is not limited herein.

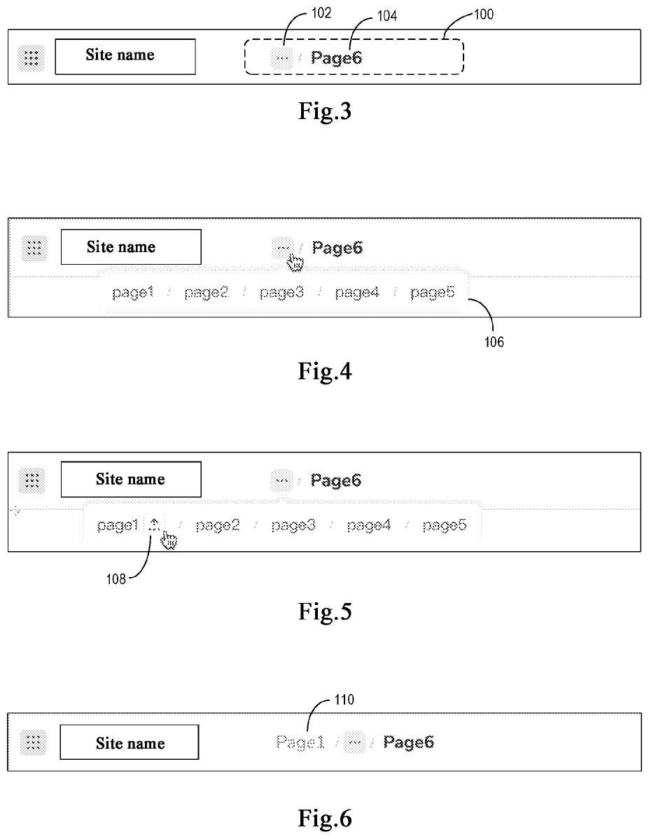

For ease of understanding, reference will be made to the page design as shown in FIGS. 3-11 to describe the display method 200 in FIG. 2, but it would be appreciated that the example page design in FIGS. 3-11 does not suggest any limitation.

As shown in FIG. 2, at block 210, display a navigation bar of a first page in a view of the first page, where the navigation bar includes an interactive element that hides path information of the first page, and a first title of the first page. The first page may be a current page that a user is visiting (the “current page” and the “first page can be used interchangeably herein). In addition to the detailed page content of the first page, the view of the first page has a navigation bar of the first page displayed therein, which includes a first title of the first page.

FIG. 3 illustrates a navigation bar 100 in the view of the first page, which includes a first title 104 (Page6) of the first page, and an interactive element 102. As shown therein, the interactive element 102 is an ellipse button, and the punctual mark “ . . . ” thereon prompts a user that more path information is hidden, to guide the user to interact therewith. The path information may be titles of a set of ordered pages. In some embodiments, the navigation bar 100 can be configured to display only the title of the current page by default.

At block 220, in response to receiving a first interactive operation to the interactive element, display a title of at least one page in the hidden path information. For example, the user can interact with the interactive element 102 in the form of an ellipsis button as shown in FIG. 3, to cause the hidden path information to be displayed. In some embodiments, the first interactive operation may be a hover operation. For example, the user moves the cursor to the interactive element 102 and keeps it there for a period of time (e.g. a few seconds). In response, the title of the page in the path information hidden by the interactive element 102 can be automatically displayed.

In some embodiments, displaying the title of the at least one page in the hidden path information may includes: displaying the title of the at least page above or below the navigation bar, based on an order of pages in the path information.

FIG. 4 illustrates a title 106 of a hidden page displayed in response to the first interactive operation. As shown therein, the title 106 is located below the navigation bar, where page1 through page5 are titles of a set of ordered pages 1-5. Following an order from left to right, page 1 is a title of a first-level page (page 1), page 2 is a title of a second-level page (page 2), . . . page 5 is a title of the page 5. In the example, the full path of the current page (page6) is page1>page2>page3>page4>page5>page6.

At block 230, in response to receiving a second interactive operation to a second title of a second page among the at least one page, add the second title the navigation bar. Through the second interactive operation, the user can add titles of the one or more hidden pages to the navigation bar 100. In this way, the user can set whether a specific page is hidden or not according to his/her need, to obtain a customized navigation bar, and thus solve the problem that the existing navigation bar is lengthy and fixed in content.

In some embodiments, a first control for adding the second title to the navigation bar is displayed at or around the second title. In response to receiving the second interactive operation to the first control, the second title is added to the navigation bar.

FIG. 5 illustrates an example interface and operation for adding a title of a hidden page to a navigation bar. As shown therein, a control 108 for adding the page 1 to the navigation bar 100 is located next to the title page1 of the page 1. In some embodiments, the control 108 is not displayed by default, as shown in FIG. 4; when the user moves the cursor close to the page1 (for example, the cursor hovers there), the control 108 is displayed next to page1, which can save the display space. Alternatively, the control 108 can be fixedly displayed close to each title 106. When the user performs the second interactive operation by clicking on the control 108, the title 110 (Page1) of the page 1 is added to the navigation bar, as shown in FIG. 6.

In some embodiments, the first title is displayed in the navigation bar in a more prominent manner than the second title, to thus highlight the title of the current page. For example, the first title may be in a special font, for example, of a bold type, a large size, or a bright color, and the second title can be displayed with a low contrast (e.g. in a grayscale font).

Adding the originally hidden title to the navigation bar implies a requirement that the titles in the navigation bar be re-arranged. In some embodiments, adding the second title to the navigation bar may include: determining, based on the path information of the first page, a position of the second title in the navigation bar; and updating the navigation bar based on the determined position of the second title.

Referring to FIG. 6, according to the path information, the added page 1 is a first-level page, and the title page1 thereof is thus located at the leftmost side. In some embodiments, the position of the interactive element in the updated navigation bar is determined based on the order of pages in the path information. As shown in FIG. 6, the interactive element (represented by the ellipsis button “ . . . ”) that hides the page 2 through the page 5 is located between the titles Page 1 and Page 6 already displayed in the navigation bar.

In some embodiments, updating the navigation bar may include: determining at least one third page in the path information that is not displayed in the navigation bar; and displaying, in the navigation bar, one or more interactive elements that hide the at least one third page. As shown in FIG. 6, when the title of the page 1 is added to the navigation bar, the titles of the page 2 through the page 5 located between the page 1 and the page 6 are not displayed in the navigation bar, and the page 2 through the page 5 are therefore hidden using the ellipsis button in the updated navigation bar.

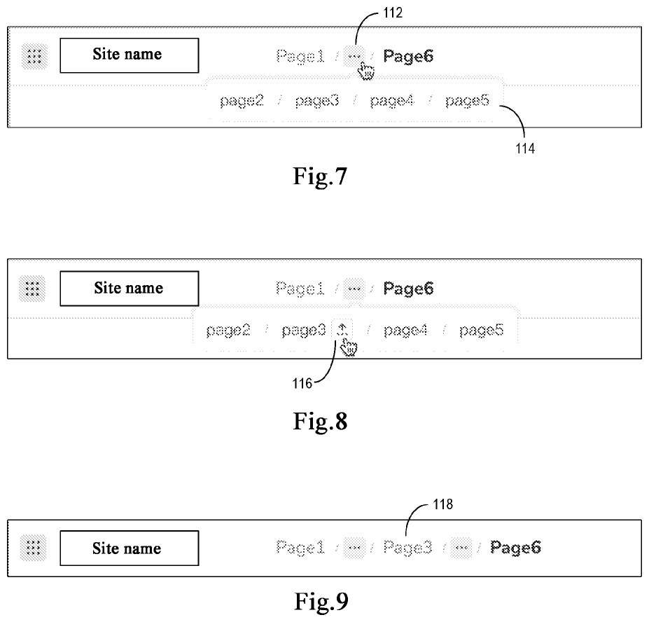

Referring to FIG. 7, in the case, if the user clicks on the ellipsis button 112, titles114 of the page 2 through the page 5 are displayed below the navigation bar. Then, in the similar manner described with reference to FIG. 5, the user can select any one of them and add the same to the navigation bar.

In some cases, adding a title of a hidden page to the navigation bar may cause two new interactive elements or ellipsis buttons to be generated in the navigation bar. As shown in FIG. 8, the user selects a title 116 (page3) of the page 3 and then adds the same to the navigation bar. Correspondingly, in addition to the title (Page 1) of the page 1 and the title (Page 6) of the current page, the title (Page 3) of the page 3 is displayed in the updated navigation bar. Based on the path information, the page 2 between the page 1 and the page 3, and the pages 4 and 5 between the page 3 and the current page are not displayed in the navigation bar. As such, the navigation bar includes two ellipsis buttons that hide the page 2, and the pages 4 and 5, respectively. The positions of those pages are also determined based on the path information.

In some embodiments, the user can remove an added page title from the navigation bar. In this way, the user can further flexibly customize the information displayed in the navigation bar. In some embodiments, a second control for removing the title from the navigation bar can be displayed at or around the title in the navigation bar. In response to receiving a third interactive operation to the second control, the second title is removed from the navigation bar. In response to the second title being removed, the navigation bar can be updated by displaying an interactive element that hides the second page.

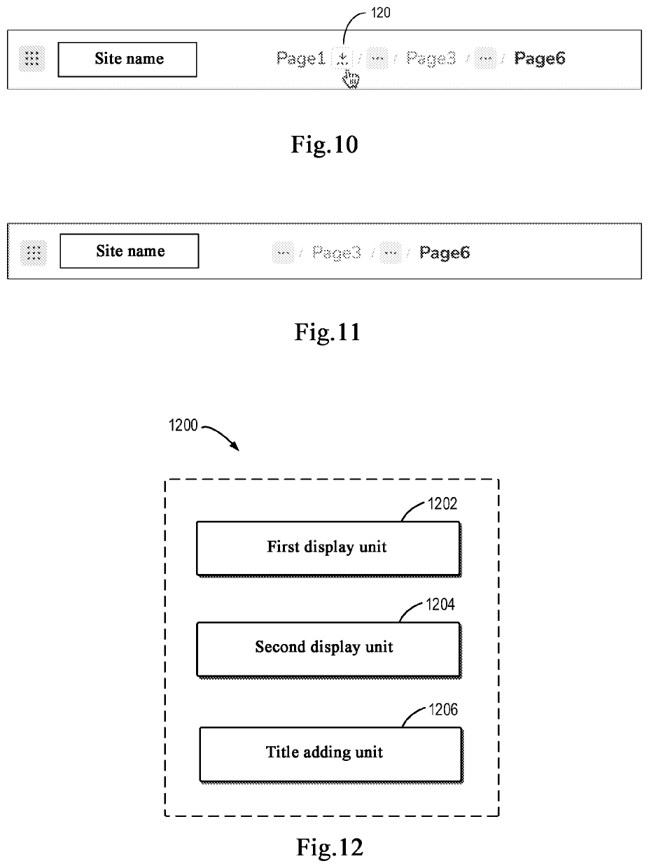

For example, referring to FIG. 10, when the curser is moved by the user to the Page1 and hovers there, a control 120 is displayed next to the Page1. If the user clicks on the control 120, the Page1 is removed from the navigation bar. The updated navigation bar is shown in FIG. 11.

The example embodiments described above with reference to FIGS. 2-11 provide a solution in which the navigation bar and the page title are integrated into a unified navigation tool, where the navigation bar can be displayed flexibly through an interactive mechanism. The navigation bar may only display the title of the current page, and provide an interactive element adjacent to the title and configured to hide path information of the current page. A user may operate the interactive element to add a hidden intermediate page title to the navigation bar or remove a displayed intermediate page title therefrom, thereby customizing the navigation bar. Compared to the prior art, the embodiments of the present disclosure satisfy the requirements of displaying both the navigation bar and the page title, maintain the functions of viewing the current title and intermediate path pages, and achieve space-saving benefits. This addresses the problem of conventional navigation bars being lengthy and fixed in content, without increasing the space occupied by the navigation area.

FIG. 12 illustrates a block diagram of an apparatus 1200 for interface display according to some embodiments of the present disclosure. As shown therein, the apparatus 1200 includes: a first display unit 1202 configured to display a navigation bar of a first page in a view of the first page, the navigation bar including an interactive element that hides path information of the first page, and a first title of the first page. The apparatus 1200 further includes: a second display unit 1204 configured, in response to receiving a first interactive operation to the interactive element, to display a title of at least one page in the hidden path information. In addition, the apparatus 1200 includes: a title adding unit 1206 configured, in response to receiving a second interactive operation to a second title of a second page among the at least one page, to add the second title to the navigation bar.

In some embodiments, the apparatus 1200 further includes a third display unit configured to display a first control for adding the second title to the navigation bar; and the title adding unit 1206 is further configured, in response to receiving the second interactive operation to the first control, to add the second title to the navigation bar.

In some embodiments, the apparatus 1200 further includes a fourth display unit configured to display a second control for removing the second title from the navigation bar. The apparatus 1200 further includes a title removing unit configured, in response to receiving a third interactive operation to the second control, to remove the second title from the navigation bar. In addition, the apparatus 1200 further includes an update unit configured to update the navigation bar by displaying an interactive element that hides the second page.

In some embodiments, the first display unit 1202 is further configured to: display, in the navigation bar, the first title in a more prominent manner than the second title.

In some embodiments, the second display unit 1204 is further configured to: display the title of the at least page above or below the navigation bar, based on an order of pages in the path information.

In some embodiments, the title adding unit 1206 is further configured to: determine, based on the path information, a position of the second title in the navigation bar; and update the navigation bar based on the determined position of the second title.

In some embodiments, the update unit is further configured to: determine at least one third page in the path information that is not displayed in the navigation bar; and display, in the navigation bar, one or more interactive elements that hide the at least one third page.

In some embodiments, a number and positions of the one or more interactive elements are determined based on an order of pages in the path information.

In some embodiments, the first interactive operation is a hover operation, and the second interactive operation is a click operation.

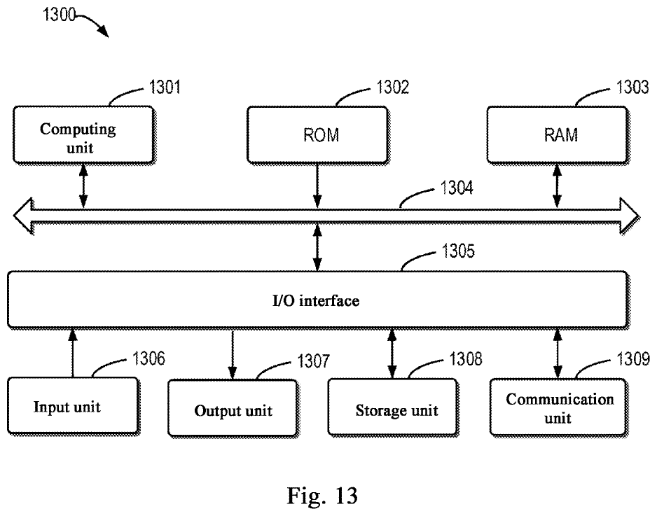

FIG. 13 illustrates an example block diagram of an example device 1300 that can implement embodiments of the present disclosure. As shown therein, the device 1300 may include a computing unit 1301 which can execute various actions and processing based on programs stored in a Read Only Memory (ROM) 1302 or a program loaded from a storage unit 1308 to a Random Access Memory (RAM) 1303. RAM 1303 stores therein various programs and data required for operations of the device 1300. The computing unit 1301, the ROM 1302, and the RAM 1303 are connected to one another via a bus 1304. An input/output (I/O) interface 1305 is also connected to the bus 1304.

A plurality of components in the device 1300 may be connected to the I/O interface 1305, including: an input unit 1306 including, for example, a keyboard, a mouse, and the like; an output unit 1307 including various types of displays, loudspeakers, and the like; a storage unit 1308 including, for example, a magnetic disk, a compact disc, or the like; and a communication unit 1309, for example, a network card, a modem, a wireless communication transceiver, or the like. The communication unit 1309 can allow the device 1300 to exchange information/data with other devices through a computer network such as Internet, and/or various kinds of telecommunication networks.

The various methods or processes described above can be performed by the computing unit 1301. For example, the method may be implemented as computer software programs that are tangibly included in a machine readable medium, e.g., the storage unit 1308. In some embodiments, part or all of the computer programs may be loaded and/or mounted onto the device 1300 via ROM 1302 and/or communication unit 1309. When the computer program is loaded to the RAM 1303 and executed by the computing unit 1301, one or more steps of the method or process as described above can be executed. Alternatively, in other embodiments, the computing unit 1301 may be configured in any other appropriate manners (for example, by means of firmware) to perform one or more steps or postures in the method or process described above.

In some embodiments, the method and process described above may be implemented as a computer program product. The computer program product may include a computer readable storage medium having stored thereon computer readable program instructions for performing various aspects of the present disclosure.

The computer readable storage medium may be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a Random Access Memory (RAM), a Read-Only Memory (ROM), an Erasable Programmable Read-Only Memory (EPROM or Flash memory), a Static Random Access Memory (SRAM), a portable Compact Disc Read-Only Memory (CD-ROM), a Digital Versatile Disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals sent through a wire.

Computer readable program instructions described herein can be downloaded to corresponding computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the corresponding computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language, and conventional procedural programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a Local Area Network (LAN) or a Wide Area Network (WAN), or the connection may be made to an external computer (for example, through the Internet using an Internet Service Provider). In some embodiments, electronic circuitry including, for example, programmable logic circuitry, Field-Programmable Gate Arrays (FPGAs), or Programmable Logic Arrays (PLAs) may execute the computer readable program instructions by utilizing state information of the computer readable program instructions to personalize the electronic circuitry, in order to perform aspects of the present disclosure.

These computer readable program instructions may be provided to a processing unit of a general purpose computer, special purpose computer, or other programmable data processing device to produce a machine, such that the instructions, when executed via the processing unit of the computer or other programmable data processing device, create apparatuses for implementing the functions/actions specified in the flowchart and/or block diagram block or blocks. These computer readable program instructions may also be stored in a computer readable storage medium that can direct a computer, a programmable data processing device, and/or other devices to function in a particular manner, such that the computer readable storage medium having instructions stored thereon includes an article of manufacture including instructions which implement aspects of the functions/actions specified in the flowchart and/or block diagram block or blocks.

The computer readable program instructions may also be loaded onto a computer, other programmable data processing devices, or other devices to cause a series of operational steps to be performed on the computer, other programmable devices or other devices to produce a computer implemented process, such that the instructions which are executed on the computer, other programmable devices, or other devices implement the functions/actions specified in the flowchart and/or block diagram block or blocks.

The flowchart and block diagrams illustrate the architecture, functionality, and operation of possible implementations of systems, methods and computer program products according to various embodiments of the present disclosure. In this regard, each block in the flowchart or block diagrams may represent a module, snippet, or portion of code, which includes one or more executable instructions for implementing the specified logical function(s). In some alternative implementations, the functions noted in the block may occur out of the order noted in the images. For example, two blocks in succession may, in fact, be executed substantially concurrently, or the blocks may sometimes be executed in the reversed order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or actions, or combinations of special purpose hardware and computer instructions.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

I/We claim:

1. A display method, comprising:
displaying a navigation bar of a first page in a view of the first page, the navigation bar including an interactive element that hides path information of the first page, and a first title of the first page;
in response to receiving a first interactive operation to the interactive element, displaying a title of at least one page in the hidden path information; and
in response to receiving a second interactive operation to a second title of a second page among the at least one page, adding the second title to the navigation bar.

2. The method of claim 1, further comprising:
displaying a first control for adding the second title to the navigation bar,
wherein adding the second title to the navigation bar comprises:
in response to receiving the second interactive operation to the first control, adding the second title to the navigation bar.

3. The method of claim 1, further comprising:
displaying a second control for removing the second title from the navigation bar; and
in response to receiving a third interactive operation to the second control, removing the second title from the navigation bar; and
updating the navigation bar by displaying an interactive element that hides the second page.

4. The method of claim 1, further comprising:
displaying, in the navigation bar, the first title in a more prominent manner than the second title.

5. The method of claim 1, wherein, in response to receiving the first interactive operation to the interactive element, displaying the title of the at least one page in the hidden path information, comprises:
displaying the title of the at least page above or below the navigation bar, based on an order of pages in the path information.

6. The method of claim 1, wherein adding the second title to the navigation bar comprises:
determining, based on the path information, a position of the second title in the navigation bar; and
updating the navigation bar based on the determined position of the second title.

7. The method of claim 6, wherein updating the navigation bar comprises:
determining at least one third page in the path information that is not displayed in the navigation bar; and
displaying, in the navigation bar, one or more interactive elements that hide the at least one third page.

8. The method of claim 7, wherein a number and positions of the one or more interactive elements are determined based on an order of pages in the path information.

9. The method of claim 1, wherein the first interactive operation is a hover operation, and the second interactive operation is a click operation.

10. An electronic device, comprising:
a processor; and
a memory coupled to the processor and having instructions stored therein, wherein the instructions, when executed by the processor, cause the electronic device to perform a method comprising:
displaying a navigation bar of a first page in a view of the first page, the navigation bar including an interactive element that hides path information of the first page, and a first title of the first page;
in response to receiving a first interactive operation to the interactive element, displaying a title of at least one page in the hidden path information; and
in response to receiving a second interactive operation to a second title of a second page among the at least one page, adding the second title to the navigation bar.

11. The electronic device of claim 10, the method further comprising:
displaying a first control for adding the second title to the navigation bar,
wherein adding the second title to the navigation bar comprises:
in response to receiving the second interactive operation to the first control, adding the second title to the navigation bar.

12. The electronic device of claim 10, the method further comprising:
displaying a second control for removing the second title from the navigation bar; and
in response to receiving a third interactive operation to the second control, removing the second title from the navigation bar; and
updating the navigation bar by displaying an interactive element that hides the second page.

13. The electronic device of claim 10, the method further comprising:
displaying, in the navigation bar, the first title in a more prominent manner than the second title.

14. The electronic device of claim 10, wherein, in response to receiving the first interactive operation to the interactive element, displaying the title of the at least one page in the hidden path information, comprises:
displaying the title of the at least page above or below the navigation bar, based on an order of pages in the path information.

15. The electronic device of claim 10, wherein adding the second title to the navigation bar comprises:
determining, based on the path information, a position of the second title in the navigation bar; and
updating the navigation bar based on the determined position of the second title.

16. The electronic device of claim 15, wherein updating the navigation bar comprises:
determining at least one third page in the path information that is not displayed in the navigation bar; and
displaying, in the navigation bar, one or more interactive elements that hide the at least one third page.

17. The electronic device of claim 16, wherein a number and positions of the one or more interactive elements are determined based on an order of pages in the path information.

18. The electronic device of claim 10, wherein the first interactive operation is a hover operation, and the second interactive operation is a click operation.

19. A non-transitory computer-readable storage medium having computer-executable instructions stored thereon, wherein the computer-executable instructions are executed by a processor to perform a method comprising:
displaying a navigation bar of a first page in a view of the first page, the navigation bar including an interactive element that hides path information of the first page, and a first title of the first page;
in response to receiving a first interactive operation to the interactive element, displaying a title of at least one page in the hidden path information; and
in response to receiving a second interactive operation to a second title of a second page among the at least one page, adding the second title to the navigation bar.

20. The non-transitory computer-readable storage medium of claim 19, the method further comprising:
displaying, a first control for adding the second title to the navigation bar,
wherein adding the second title to the navigation bar comprises:
in response to receiving the second interactive operation to the first control, adding the second title to the navigation bar.
